(19) United States
(12) Patent Application Publication
(10) Pub. No.: US 2008/0112003 A1
(43) Pub. Date: May 15, 2008

(54) IMAGE FORMING APPARATUS AND IMAGE FORMING METHOD

(75) Inventor: Kazuo Sasama, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/936,202

(22) Filed: Nov. 7, 2007

Related U.S. Application Data
(60) Provisional application No. 60/865,085, filed on Nov. 9, 2006.

(51) Int. Cl. H04N 1/00; G06K 1/00

(52) U.S. Cl. 358/1.9; 358/1.17; 358/408

(57) ABSTRACT

An image forming apparatus according to the present invention includes an image compressing unit that creates thumbnail data in page units on the basis of image data of a document scanned by a scanner unit, a first control unit that writes the thumbnail data in page units in a page memory, converts the thumbnail data into thumbnail packets in a unit of thumbnail data of plural pages and reads out the thumbnail packets, and stores the thumbnail packets in a data storage medium, and a second control unit that reads out the thumbnail packets stored in the data storage medium and stores the thumbnail packets in the page memory, selects data of an arbitrary thumbnail packet in response to user operation, and displays a thumbnail image in a unit of plural pages on a display unit of a control panel.

### CROSS-REFERENCE TO RELATED APPLICATION

This application is based upon and claims the priority of U.S. Provisional Application No. 60/865,085, filed on Nov. 9, 2006, the entire contents of which are incorporated herein by reference.

### BACKGROUND OF THE INVENTION

1. Field of the Invention

The present invention relates to image forming apparatuses such as an MFP (Multi-Function Peripheral), which is a digital complex machine, and a copying machine, and, more particularly to an image forming apparatus and an image forming method that make it possible to display thumbnail images on a control panel.

2. Description of the Related Art

In general, an image forming apparatus such as an MFP includes a scanner unit and a printer unit, scans a document with the scanner unit, processes scanned image data with an image processing unit, and prints the image data with the printer unit.

The image forming apparatus also includes an automatic document feeder (ADF). The scanner unit scans a document sent by the ADF or scans a document placed on a document table. In general, when a large quantity of documents are copied, the scanner unit scans the documents sequentially sent by the ADF.

When the documents are scanned by the scanner unit, in order to check contents of scanned image data, thumbnail images may be created. In particular, when there are a large number of documents, image data scanned by the scanner unit is temporarily stored in a storage medium such as a hard disk drive (HDDD) and thumbnail images are displayed on a control panel of the MFP to subject necessary image data to print processing referring to the thumbnail images.

In general, the thumbnail images are created by a unit of one page and stored in the HDD or the like together with the image data. When the thumbnail images are displayed on the control panel, the thumbnail images are read out from the HDD by a unit of one page and the thumbnail images for plural pages are displayed on the control panel.

However, when the thumbnail images for the plural pages are displayed on the control panel at a time, the thumbnail images in a unit of one page are read out from the HDD separately for displayed pages plural times and written on the control panel. Since the thumbnail images are separately read out plural times, there are deficiencies in that the number of times of access to the HDD increases, an access time increases, and the display of the thumbnail images on the control panel is delayed.

JP-A-2006-108894 discloses an image processing apparatus for displaying thumbnail images. The image processing apparatus suspends the display of a large volume of thumbnail images and displays the thumbnail images when the suspension is cancelled. However, when thumbnail images for plural pages are displayed at a time, there is a deficiency in that the display is delayed.

The present invention provides an image forming apparatus and an image forming method for reducing a delay in display when thumbnail images for plural pages are displayed on a control panel or when the display of the thumbnail images is switched.

### DESCRIPTION OF THE DRAWINGS

FIG. 1 is a schematic diagram showing an image forming apparatus according to an embodiment of the present invention;

FIG. 2 is a block diagram of a control system of the image forming apparatus according to the embodiment;

FIGS. 3A and 3B are timing charts showing operations for transferring compressed image data and thumbnail data in the image forming apparatus according to the embodiment;

FIGS. 4A, 4B, and 4C are explanatory diagrams showing operations for controlling a page memory in the image forming apparatus according to the embodiment;

FIG. 5 is an explanatory diagram showing a method of storing compressed image data and thumbnail data in the image forming apparatus according to the embodiment;

FIGS. 6A and 6B are explanatory diagrams showing an example of display of thumbnail images on a control panel of the image forming apparatus according to the embodiment;

FIGS. 7A and 7B are explanatory diagrams showing another example of the display of thumbnail images on the control panel of the image forming apparatus according to the embodiment;

FIGS. 8A and 8B are explanatory diagrams showing an example of color display and monochrome display of thumbnail images in the image forming apparatus according to the embodiment; and

FIGS. 9A and 9B are explanatory diagrams showing processing of a thumbnail packet in a page memory of the image forming apparatus according to the embodiment.

### DESCRIPTION OF THE EMBODIMENTS

Throughout this description, the embodiments and examples shown should be considered as exemplars, rather than limitations on the apparatus of the present invention.

An embodiment of the present invention will be hereinafter explained in detail with reference to the accompanying drawings. Identical components in the respective figures are denoted by identical reference numerals and signs.

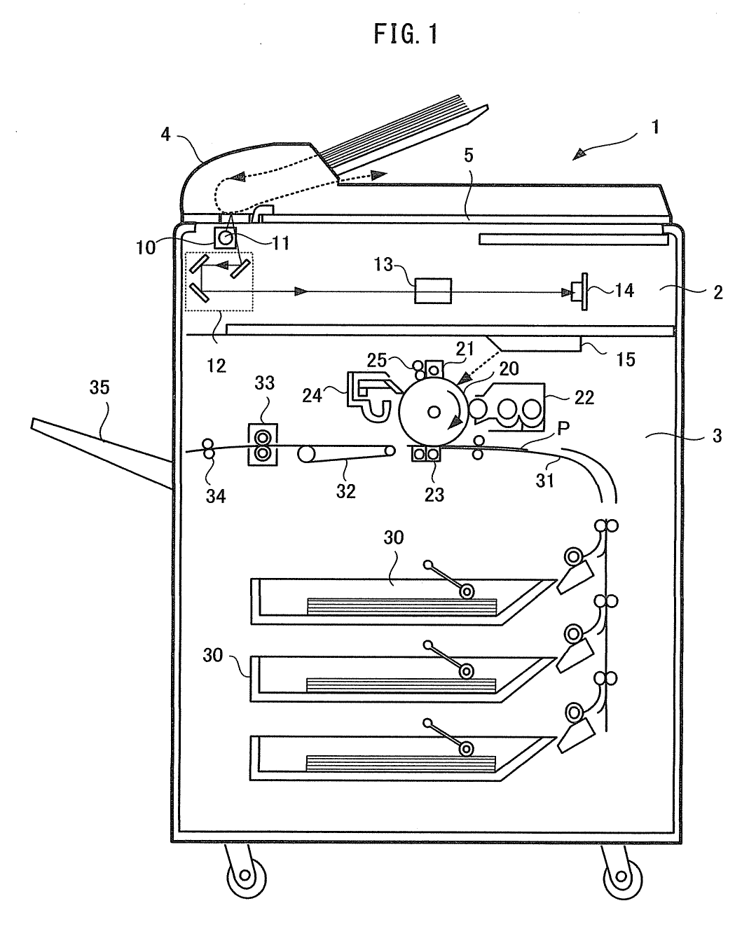

FIG. 1 is a schematic diagram showing an embodiment of an image forming apparatus according to the present invention. In FIG. 1, an MFP (Multi-Function Peripheral) is explained as an example of the image forming apparatus. However, the present invention is also applicable to a copying machine and the like.

An image forming apparatus 1 includes a scanner unit 2 and a printer unit 3. The image forming apparatus 1 also includes, in an upper part thereof, an automatic document feeder (ADF) 4 and a transparent document table 5. The scanner unit 2 scans an image of a document. The printer unit 3 forms an image on a sheet on the basis of scanned data.

The scanner unit 2 includes a carriage 10, an exposure lamp 11 provided in the carriage 10, a reflection mirror 12, a lens 13, a CCD (Charge Coupled Device) 14 that captures reflected light from the reflection mirror 12, and a laser unit 15.

In order to scan a document placed on the document table 5 or a document sent by the automatic document feeder 4, the scanner unit 2 irradiates light of the exposure lamp 11 provided in the carriage 10 on the document from below the document table 5 and captures reflected light from the document into the CCD 14 via the reflection mirror 12 and the lens 13.

Image information captured into the CCD 14 is outputted as an analog signal. The analog signal is converted into a digital signal and subjected to image processing to create image data. The image data is supplied to the laser unit 15. The laser unit 15 generates a laser beam in accordance with the image data.

The printer unit 3 has a photoconductive member 20. The printer unit 3 includes, around the photoconductive member 20, a charging device 21, a developing device 22, a transfer device 23, a cleaner 24, and a charge removing lamp 25 along a rotating direction of the photoconductive member 20. The laser beam from the laser unit 15 is irradiated on the photoconductive member 20. An electrostatic latent image corresponding to the image information of the document is formed and held on the outer peripheral surface of the photoconductive member 20.

When image formation is started, the charging device 21 discharges electricity in a predetermined discharge position and uniformly charges the outpour peripheral surface of the rotating photoconductive member 20 in an axial direction with a predetermined charge. Then, the laser beam is irradiated on the photoconductive member 20 from the laser unit 15 and an electrostatic latent image is formed and held on the outer peripheral surface of the photoconductive member 20.

A developing agent (e.g., a toner) is provided to the outer peripheral surface of the photoconductive member 20 from the developing device 22. The electrostatic latent image is converted into a toner image and developed. A developing roller is rotatably provided in the developing device 22 to be opposed to the photoconductive member 20. The toner is supplied to the photoconductive member 20 according to the rotation of the developing roller.

The toner image formed on the outer peripheral surface of the photoconductive member 20 is electrostatically transferred onto a sheet P by the transfer device 23. The sheet P is conveyed from a paper feeding device 30 described later through a conveying path 31. The toner not transferred and remaining on the photoconductive member 20 is removed by the cleaner 24 located downstream in the rotating direction of the photoconductive member 20. After the removal of the toner, residual charges on the outer peripheral surface of the photoconductive member 20 are removed by the charge removing lamp 25.

The structure of the printer unit 3 is not limited to the example shown in the figure. It is also possible to use other systems, for example, a system that uses an intermediate transfer belt.

On the other hand, in order to supply sheets to the printer unit 3, plural paper feeding devices 30 are provided in a lower part of the printer unit 3. The sheets from the paper feeding devices 30 are conveyed to the transfer device 23 by a conveyor belt 31.

The sheet P having the toner image transferred thereon by the printer unit 3 is conveyed to a fixing device 33 through the conveyor belt 32. A heating roller and a pressing roller are provided to be opposed to each other in the fixing device 33. When the sheet P is sent through a space between the heating roller and the pressing roller, the toner image transferred onto the sheet P is fixed on the sheet P. The sheet P having the toner image fixed thereon and subjected to the image formation is discharged to a tray 35 by paper discharge rollers 34.

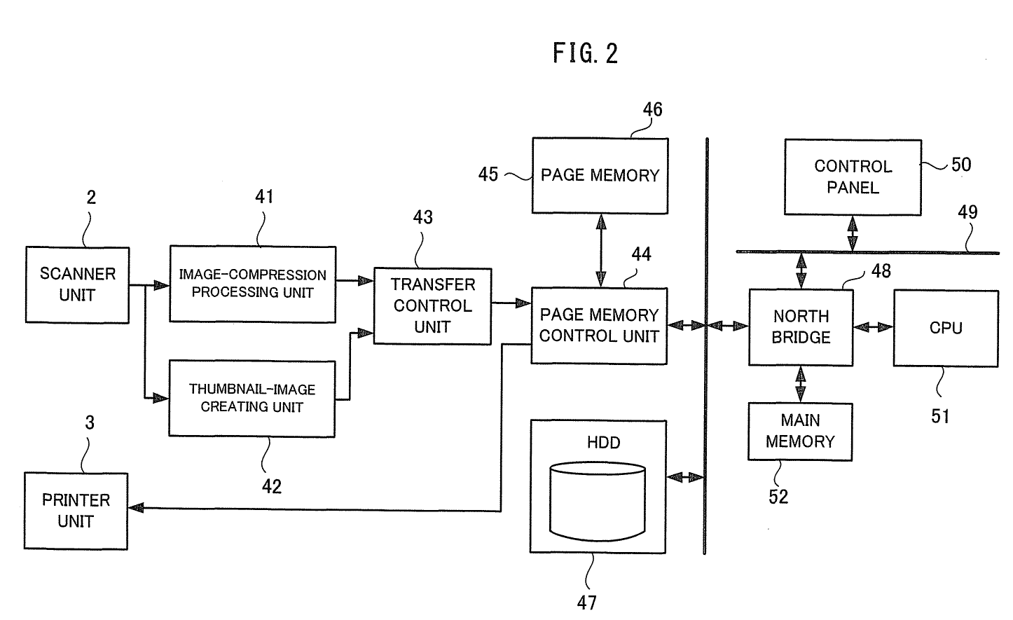

FIG. 2 is a block diagram of a control system of the image forming apparatus according to the embodiment.

In FIG. 2, the scanner unit 2 is connected to an image-compression processing unit 41 and a thumbnail-image creating unit 42. Image data of a document scanned by the scanner unit 2 is supplied to the image-compression processing unit 41 and the thumbnail-image creating unit 42. The image-compression processing unit 41 performs compression processing to create image compressed data. The thumbnail-image creating unit 42 constitutes an image compressing unit and creates thumbnail data according to, for example, thinning-out processing.

The image compressed data created by the image-compression processing unit 41 and the thumbnail data created by the thumbnail-image creating unit 42 are transferred to a page-memory control unit 44 through a transfer control unit 43.

A page memory 45 is connected to the page-memory control unit 44. The page-memory control unit 44 is connected to a PCI (Peripheral Component Interconnect) bus 46. The page-memory control unit 44 controls writing of data in the page memory 45, and readout of data from the page memory 45. The page-memory control unit 44 is connected to the printer unit 3.

A storage medium 47 for image data such as an HDD is connected to the PCI bus 46 (in the following explanation, a data storage medium is referred to as HDD 47).

The PCI bus 46 is connected to a local bus 49 through a north bridge 48. A control panel 50 is connected to the local bus 49. The control panel 50 includes a touch panel that has a display unit and is provided in an upper part of the image forming apparatus 1.

A CPU 51 and a main memory 52 are connected to the north bridge 48. The north bridge 48 arbitrates and controls input and output of data among the CPU 51, the main memory 52, a device (the control panel 50 in this context) connected to the local bus 49, devices (the HDD 47 and the page-memory control unit 44 in this context) connected to the PCI bus 46, and the like. The CPU 51 controls operations of the entire image forming apparatus 1. The main memory 52 stores various kinds of information.

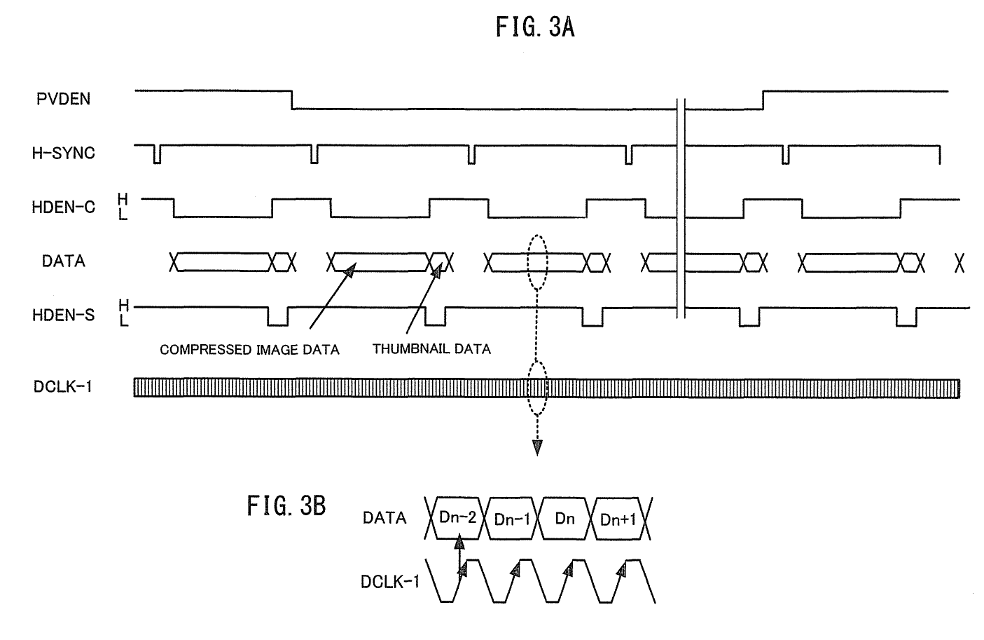

FIG. 3A is a timing chart in transferring transfer data including compressed image data and thumbnail data from the transfer control unit 43 to the page-memory control unit 44.

In FIG. 3A, PVDEN is a signal indicating a term of validity in page units of a document, H-SYNC is a horizontal synchronizing signal, HDEN-C is a horizontal enable signal for compressed image data, and HDEN-S is a horizontal enable signal for thumbnail data. DATA is a common data line for compressed image data DATA-C and thumbnail data DATA-S. DCLK-1 is a transfer clock.

The transfer control unit 43 transfers the compressed image data DATA-C by a unit of one line in synchronization with the horizontal synchronizing signal H-SYNC shown in FIG. 3A. In transferring the compressed image data DATA-C, the compressed image data DATA-C is put on the common data line DATA in a low period “L” of the horizontal enable signal HDEN-C and transferred in synchronization with the transfer clock DCLK-1.

After the transfer of the compressed image data DATA-C, the thumbnail data DATA-S is transferred in a period of a horizontal synchronizing signal of the same one line. In this case, the thumbnail data DATA-S is put on the common data line DATA in a low period “L” of the horizontal enable signal HDEN-S and transferred in synchronization with the transfer clock DCLK-1.

The compressed image data DATA-C and the thumbnail data DATA-S are transferred to the page-memory control unit 44 at time division timing of the horizontal enable signals HDEN-C and HDEN-S. The transfer of these data is performed by page units according to the PVDEN signal indicating a term of validity in page units.

FIG. 3B is a diagram showing DATA and DCLK-1 in enlargement.

The compressed image data DATA-C and the thumbnail data DATA-S transferred from the transfer control unit 43 to the page-memory control unit 44 are written in the page memory 45 under the control by the page-memory control unit 44, read out according to predetermined readout control, and then stored in the HDD 47.

When a print instruction is received, the compressed image data DATA-C stored in the HDD 47 is read out from the HDD 47 under the control by the page-memory control unit 44, supplied to the printer unit 3, and subjected to print processing. When thumbnail images are displayed on the control panel 50, the thumbnail data DATA-S stored in the HDD 47 is read out from the HDD 47 and supplied to the control panel 50 through the page memory 45.

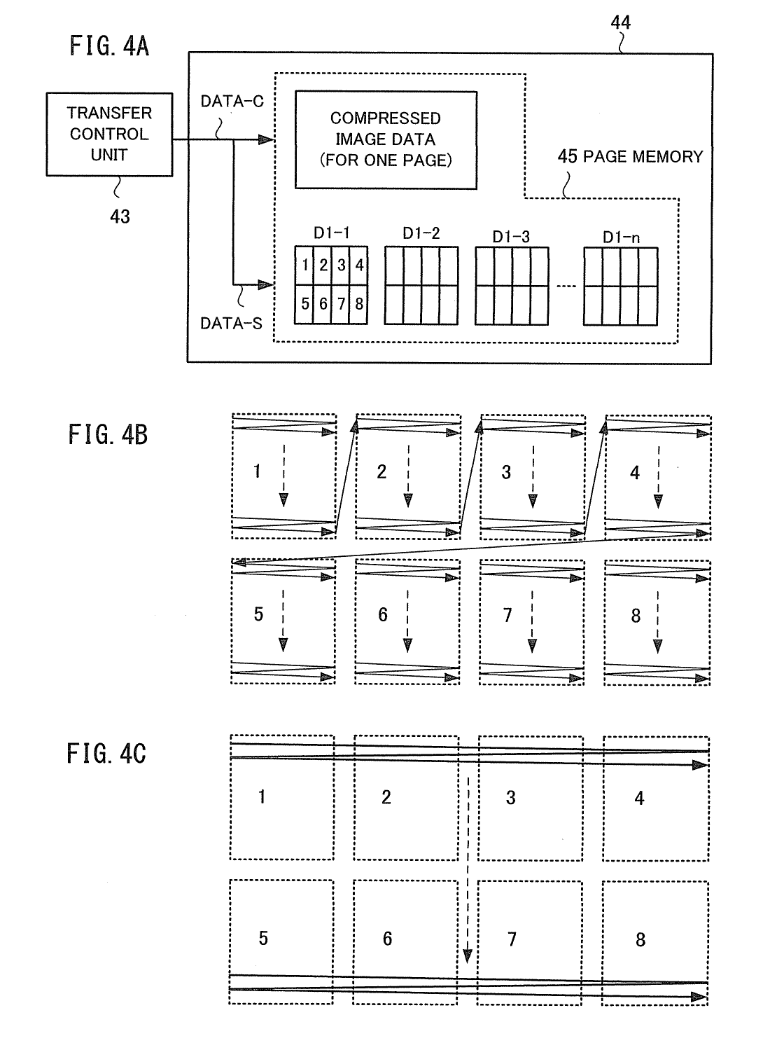

Processing for writing data in and reading out data from the page memory 45 by the page-memory control unit 44 is explained with reference to FIGS. 4A, 4B, and 4C.

FIG. 4A is a diagram showing how the compressed image data DATA-C and the thumbnail data DATA-S are written in the page memory 45.

The page-memory control unit 44 writes the compressed image data DATA-C and the thumbnail data DATA-S transferred from the transfer control unit 43 in the page memory 45. At this point, the compressed image data DATA-C and the thumbnail data DATA-S are stored in separate storage areas of the page memory 45.

In other words, the page-memory control unit 44 separates the compressed image data DATA-C and the thumbnail data DATA-S using the HDEN-C signal and the HDEN-S signal and writes the compressed image data DATA-C and the thumbnail data DATA-S in separate storage areas of the page memory 45.

The compressed image data DATA-C written in the page memory 45 is stored as data in a unit of one page. The thumbnail data DATA-S is stored in a unit of plural pages.

It is possible to simultaneously display plural thumbnail images on one screen of the control panel 50. Thus, thumbnail data for plural pages that can be displayed on one screen of the control panel 50 is stored as a unit. In an example shown in FIG. 4A, thumbnail data D1-1, D1-2, . . . , and D1-n in a unit of eight pages are sequentially stored.

FIG. 4B is a diagram showing a writing order in writing thumbnail data in the page memory 45.

For example, when the thumbnail data is written in the page memory 45 by a unit of 8 pages, the page-memory control unit 44 writes a first one page from the upper left to the right and from the top to the bottom of the storage area 1. When the writing of the thumbnail data for the first page is finished, the page-memory control unit 44 shifts to a storage area 2 on the right and writes the thumbnail data from the upper left to the right and from the top to the bottom of the storage area 2 in the same manner.

After the thumbnail data is sequentially written in the storage areas 1, 2, 3, and 4 in the horizontal direction, the page-memory control unit 44 shifts to a storage area 5 on the left of a lower stage and sequentially writes the thumbnail data in the storage areas 6, 7, and 8 in the horizontal direction in the same manner. Gap data is written among respective pages. In this way, the thumbnail data of the plural pages are two-dimensionally written in plural storage areas adjacent to one another of the page memory 45, respectively.

The thumbnail data for eight pages (1 to 8) of the document and the data including the gap data among the pages form thumbnail data for one screen displayed on the control panel 50. Page processing is performed to change writing positions of pages 1 to 8 according to timing of a PVDEN signal.

When the writing for the thumbnail data for one screen (pages 1 to 8) of the control panel 50 is completed, writing of thumbnail data for the next one screen (pages 9 to 16) is performed.

FIG. 4C is a diagram showing an order for reading out thumbnail data for one screen of the control panel from the page memory 45.

In the readout from the page memory 45, the page-memory control unit 44 scans the thumbnail data for one screen (pages 1 to 8) in a traversing manner and reads out line data of pages 1, 2, 3, and 4 in the right direction from the upper left of the storage areas 1 to 4 on the upper stage. Then, returning to the left end, the page-memory control unit 44 reads out the next line data to the right end again. Subsequently, the page-memory control unit 44 sequentially reads out line data including gap data among the pages from the top to the bottom.

When the readout from the storage areas 1 to 4 on the upper stage is finished, the page-memory control unit 44 shifts to the pages 5, 6, 7, and 8 from the upper left to the right and sequentially reads out data in the storage areas 5 to 7 on the lower stage including gap data among pages from the top to the bottom in the same manner. In other words, the page-memory control unit 44 two-dimensionally scans all the plural storage areas 1 to 8 and reads out the thumbnail data for the plural pages as a unit.

In this way, the thumbnail data for one screen (the pages 1 to 8) is written in the HDD 47 under the control by the page-memory control unit 44. The order of readout from the page memory 45 and an order of writing in the HDD 47 are the same.

The thumbnail data written in the HDD 47 is read out when the thumbnail data is displayed on the control panel 50. In this case, the thumbnail data read out from the HDD 47 is temporarily written and held in the page memory 45, read out from the page memory 45, and supplied to the control panel 50. An order of readout from the page memory 45 is the same as the order shown in FIG. 4C.

The compressed image data DATA-C stored in the HDD 47 is read into the page memory 45 in print processing and sequentially subjected to the print processing by the printer unit 3. When the print processing is finished, the compressed image data DATA-C is deleted from the page memory 45.

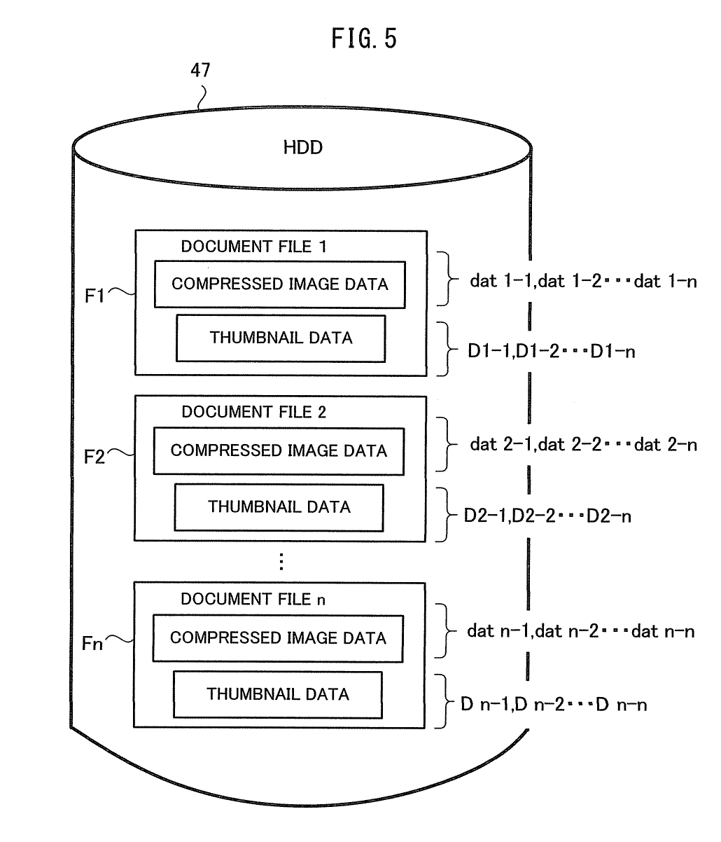

FIG. 5 is a diagram showing a method of storing the compressed image data and the thumbnail data in the HDD 47.

The compressed image data and the thumbnail data stored in the page memory 45 are transferred to the HDD 47. In the HDD 47, the compressed image data and the thumbnail data are stored by a unit of document file.

The unit of document file indicates that plural documents scanned by the scanner unit 2 are grasped as one related file. Therefore, plural compressed image data in a unit of one page and plural thumbnail data in a unit of one screen of the control panel are stored in one document file in the HDD 47.

For example, in a document file F1, compressed image data dat1-1 on a first page to compressed image data dat1-n on an nth page are stored (n indicates a total number of pages of the document file 1). In the document file F1, thumbnail data D1-1 to D1-n in a unit of eight pages are also stored.

Similarly, in a document file F2, compressed image data dat2-1 on the first page to compressed image data dat2-n on the nth page and thumbnail data D2-1 to D2-n in a unit of eight pages are stored. In a document file Fn, compressed image data datn-1 on the first page to compressed image data datn-n on the nth page and thumbnail data Dn-1 to Dn-n in a unit of eight pages are stored.

Each of the data D1-1, D1-2, . . . , and Dn-n in a unit of thumbnail data of plural pages is referred to as a thumbnail packet in the following explanation.

The number of thumbnails that can be simultaneously displayed on one screen of the control panel 50 is n (n is plural, e.g., eight) on one screen. One thumbnail packet is formed with thumbnail data for m pages (m≦n) of a document as a unit.

The thumbnail packets D1-1, D1-2, . . . , and Dn-n are read out from the HDD 47 under the control by the page-memory control unit 44. A fixed quantity of thumbnail packets are stored in the page memory 45. An arbitrary thumbnail packet stored in the page memory 45 is read out and supplied to the control panel 50.

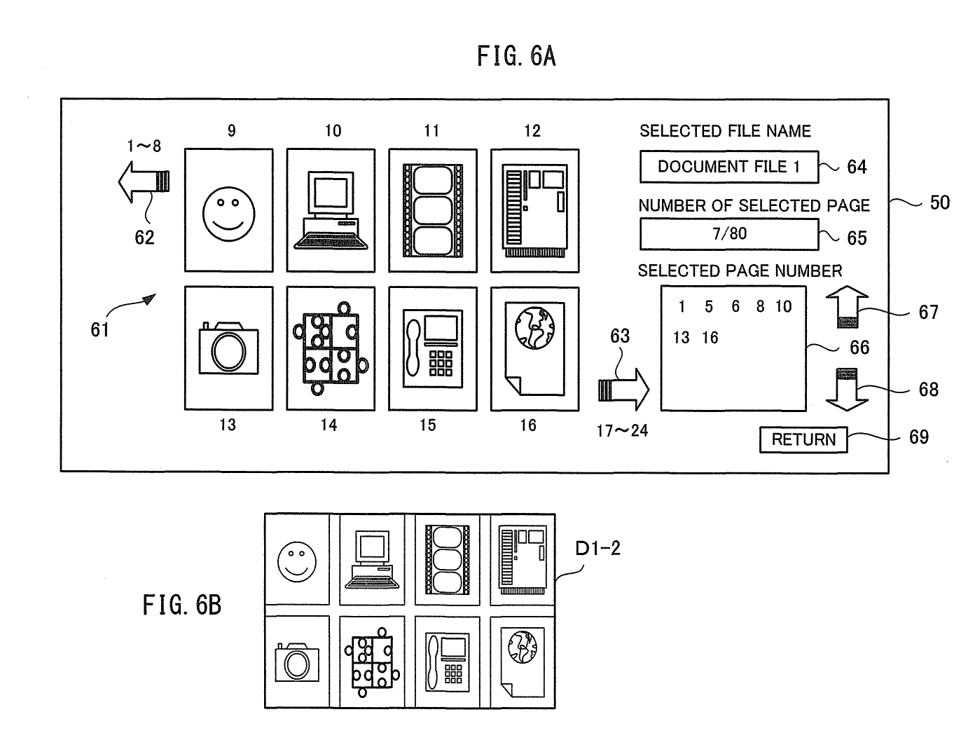

FIG. 6A shows an example of display of thumbnail images on the control panel 50. In the example in FIG. 6A, eight thumbnail images 61 (for pages 9 to 16) are displayed on the control panel 50. The plural thumbnail images 61 are referred to as a thumbnail group.

Arrow icons 62 and 63 for selecting the thumbnail group are displayed on the control panel 50. When a user touches the icon 62, the preceding thumbnail group (for pages 1 to 8) is displayed. When the user touches the icon 63, it is possible to selectively display the next thumbnail group (for pages 17 to 24).

When the user touches any one of the displayed thumbnail images 61 and selects the thumbnail image, it is possible to perform print setting. The thumbnail image is subjected to print processing by the printer unit 3. Since the control panel 50 is the touch panel, the user can select an image of a page, which the user desires to print, out of the thumbnail images 61 and touch the image with a finger to thereby perform print processing. When the user desires to reset the thumbnail images 61 to an unselected state, the user can do so by touching the thumbnail image on the same page again with a finger or the like.

On the control panel 50, a selected file name box 64, a selected number of pages box 65, a selected page number box 66, arrow icons 67 and 68, and a return button 69 are also displayed.

A selected file name is displayed in the box 64. The selected file name corresponds to the document files F1 to Fn in FIG. 5. An example in which the document file 1 is selected is shown in FIG. 6A. The number of pages for which print setting is performed among the total number of pages of the selected document file is displayed in the box 65. The page number for which print setting is performed is displayed in the box 66.

In the example in FIG. 6A, a total page of the document file 1 is eighty and the number of pages for which print setting is performed is seven. Page numbers for which print setting is performed are 1, 5, 6, 8, 10, 13, and 16 (seven in total).

The arrow icons 67 and 68 are icons to be scrolled up and down to check a selected page number when many page numbers are displayed in the box 66. The return button 69 is used for finishing a thumbnail setting screen.

FIG. 6B shows an example of data of a thumbnail packet stored in the page memory 45 and the HDD 47. The thumbnail packet D1-2 in FIG. 6B represents display data of the thumbnail group (for pages 9 to 16) displayed in FIG. 6A.

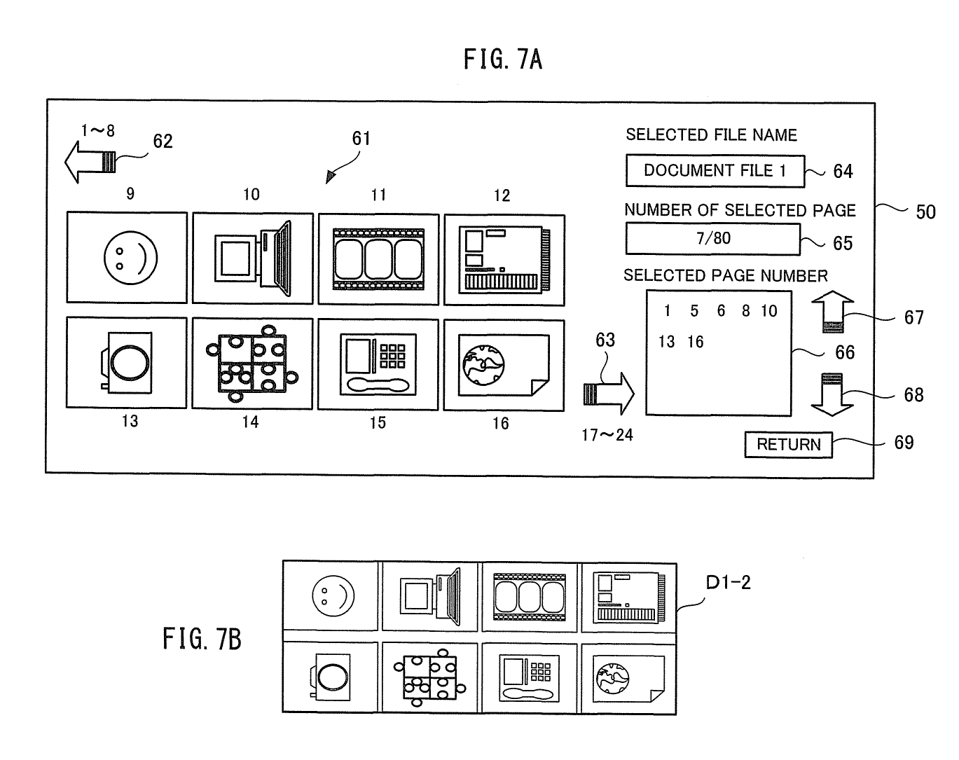

FIG. 7A shows an example of display of the thumbnail images 61 displayed when a document is sent to the scanner 2 sideways. In this case, the document sent sideways by the ADF 4 is scanned by the scanner 2 and the laterally long thumbnail images 61 are displayed on the control panel 50.

An operation for scanning the document sent sideways and writing thumbnail data in the page memory 45 is the same as that explained with reference to in FIG. 4B. The thumbnail data is read out from the page memory 45 according to a method same as that explained with reference to FIG. 4C.

In this case, as in the above case, the number of thumbnails that can be simultaneously displayed on one screen of the control panel 50 is eight. A thumbnail group for eight pages of the document is selectively displayed. In the example in FIG. 7A, the thumbnail group 61 for pages 9 to 16 is displayed laterally long on the control panel 50.

In FIG. 7A, as in FIG. 6A, the arrow icons 62 and 63 for selecting a thumbnail group are displayed on the control panel 50. The user can select and display the preceding thumbnail group (for pages 1 to 8) or the next thumbnail group (for pages 17 to 24) by touching the icons 62 and 63.

Similarly, when the user touches and selects any one of the displayed thumbnail images 61, it is possible to perform print setting. When the user desires to reset the thumbnail images 61 to an unselected state, the user can do so by touching the thumbnail image on the same page again with a finger or the like.

On the control panel 50, the selected file name box 64, the selected number of pages box 65, and the selected page number box 66 are displayed and the arrow icons 67 and 68 and the return button 69 are also displayed.

FIG. 7B shows an example of a thumbnail packet stored in the page memory 45 and the HDD 47. The thumbnail packet D1-2 in FIG. 7B is data of the thumbnail group (for pages 9 to 16) displayed in FIG. 7A.

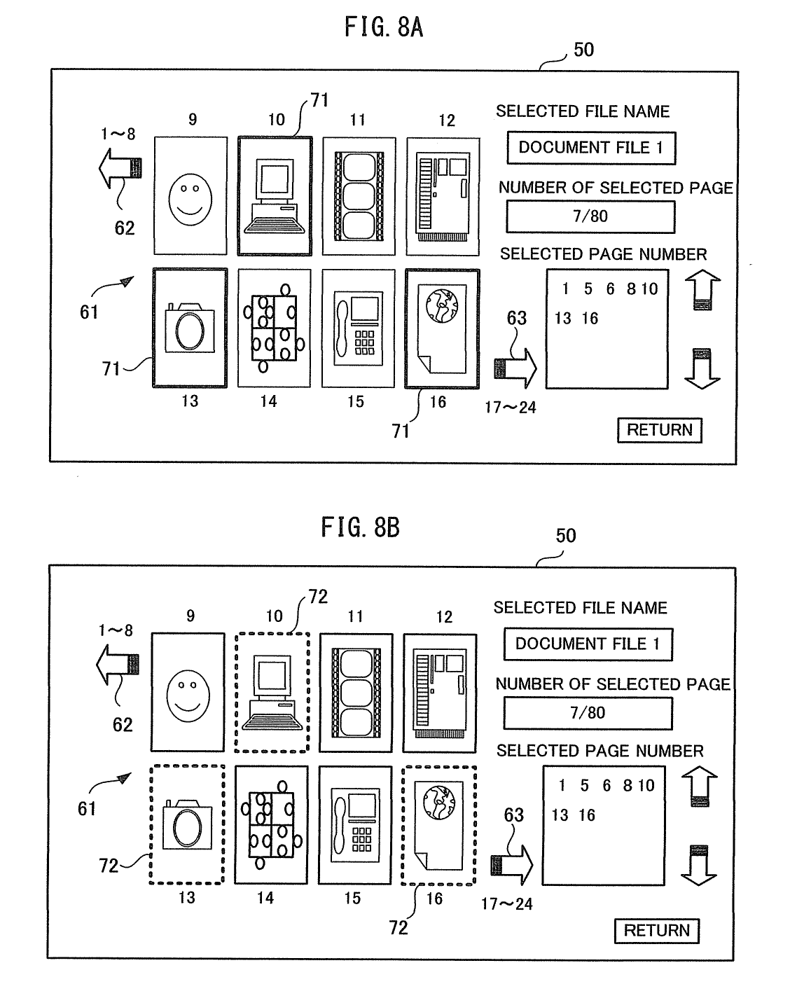

FIG. 8A shows the thumbnail images 61 displayed on the control panel 50 that is capable of performing color display. The user touches any one of the displayed thumbnail images 61 and performs print setting.

In the case of color display, when the user selects a thumbnail image of a page, which the user desires to print, out of the thumbnail images 61, the selected thumbnail image is displayed with, for example, a red frame 71. In an example in FIG. 8A, thumbnail images of pages 10, 13, and 16 are selected. The red frames 71 are overwritten on the thumbnail images of the respective pages.

The frame 71 is displayed in red. However, the frame 71 may be displayed in other colors as long as it is possible to distinguish the selected thumbnail image from other unselected thumbnail images. In general, when the selected thumbnail image is distinguished, a color of the entire thumbnail image may be changed. However, since it is necessary to overwrite a specific color image on a thumbnail image, a data amount increases. Therefore, if the frame 71 is overwritten, it is possible to reduce the data amount.

FIG. 8B shows the thumbnail images 61 displayed on the control panel 50 for monochrome display. The user touches any one of the displayed thumbnail images 61 and performs print setting.

In the case of monochrome display, when the user selects a thumbnail image of a page, which the user desires to print, out of the thumbnail images 61, the selected thumbnail image is displayed with, for example, a dotted line frame 72. In an example in FIG. 8B, thumbnail images of pages 10, 13, and 16 are selected. The dotted line frames 72 are overwritten on the thumbnail images of the respective pages.

The frame 72 is displayed in a dotted line. However, the frame 72 may be displayed in a bold line and the like as long as it is possible to distinguish the selected thumbnail image from other unselected thumbnail images.

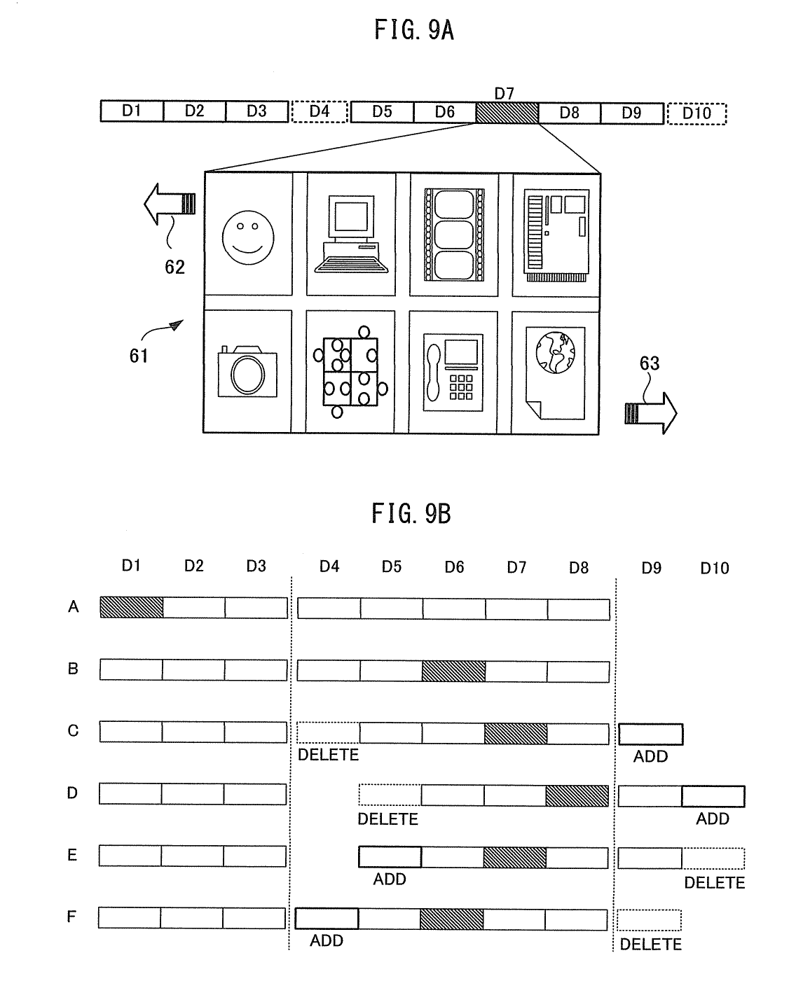

FIGS. 9A and 9B are diagrams showing a method of processing a thumbnail packet in the page memory 45 when the thumbnail images 61 are displayed on the control panel 50.

When the thumbnail image 61 is displayed on the control panel 50, the thumbnail packet stored in the HDD 47 is read and held in the page memory 45. In this case, the plural thumbnail packets D1-1, D1-2, and the like are read into the page memory 45 and sequentially supplied to the control panel 50. This makes it possible to increase speed of display.

If the thumbnail packet is directly supplied from the HDD 47 to the control panel 50, since a processing time of the HDD 47 is longer than that of the page memory 45, display speed falls when the display of thumbnail images is switched.

Therefore, the plural thumbnail packets D1-1, D1-2, and the like are read into the page memory 45. Since there is a limit in a data capacity of the page memory 45, processing described below is performed.

FIG. 9A shows thumbnail data stored in the page memory 45.

For example, thumbnail images for eight pages are displayed on one screen of the control panel 50 using ten thumbnail packets D1 to D10. As a capacity of the page memory 45, eight thumbnail packets can be stored in the page memory 45 at a time.

In FIG. 9A, data of the seventh thumbnail packet D7 (a shaded part) among the ten thumbnail packets D1 to D10 is displayed. In this case, it is possible to select and display data of the preceding thumbnail packets (D6, D5, etc.) or the next thumbnail packets (D8, D9, and D10) with the arrow icons 62 and 63. However, data that can be stored in the page memory 45 at a time is only eight thumbnail packets.

Therefore, since two thumbnail packets exceed the capacity of the page memory 45, the two thumbnail packets need to be deleted from the page memory 45. Thus, the page-memory control unit 44 stores the thumbnail packets (D1 to D3) near the top, the thumbnail packet D7 presently displayed (selected), and the thumbnail packets D5, D6, D8, and D9 located before and behind the selected packet D7 in the page memory 45 and deletes the other thumbnail packets D4 and D10 from the page memory 45 or does not store the thumbnail packet D4 and D10 in the page memory 45.

Consequently, thumbnail packets that fit in the capacity of the page memory 45 are always secured. Thumbnail packets that should be deleted depend on a thumbnail packet displayed on the control panel 50.

FIG. 9B is a diagram showing how thumbnail packets stored in the page memory 45 shift when a thumbnail group on the control panel 50 is switched.

D1 to D10 in the lateral direction in FIG. 9B indicate thumbnail packets and A to F on the ordinate indicate several display patterns. In FIG. 9B, shaded parts represent thumbnail packets selected to be displayed, dotted lines represent thumbnail packets to be deleted from the page memory 45, and bold lines represent thumbnail packets additionally written in the page memory 45.

Data of the thumbnail packets D1, D2, D3, . . . , and D10 are selected and displayed in order in the control panel 50 by using the arrow icon 63. When a display screen is returned to a preceding state during the display of the data, it is possible to select and display the thumbnail packets in an opposite order of D10, D9, D8, . . . , and D1 by using the arrow icon 62.

For example, a pattern A shows a screen immediately after the display of a thumbnail image is selected anew in a state in which another screen is displayed on the control panel 50 in FIG. 6A. In the pattern A, data of the thumbnail packet D1 at the top is displayed and the following thumbnail packets D2 to D8 are stored in the page memory 45.

In a pattern B, data of the thumbnail packet D6 is displayed and the thumbnail packets D1 to D3 near the top, the thumbnail packet D6 displayed, and the thumbnail packets D4, D5, D7, and D8 before and behind the thumbnail packet D6 are stored in the page memory 45. In the pattern A and the pattern B, the eight thumbnail packets D1 to D8 are stored.

On the other hand, a pattern C indicates a screen on which data of the thumbnail packet D7 is displayed instead of the display of the thumbnail packet D6 of the pattern B. In the pattern C, the thumbnail packets D1 to D3 near the top, the thumbnail packet D7 displayed, and the thumbnail packets D5, D6, D8, and D9 before and behind the packet D7 are stored in the page memory 45. In this case, the thumbnail packet D4 is deleted from the page memory 45 and the thumbnail packet D9 is added.

A pattern D indicates a screen on which data of the thumbnail packet D8 is displayed instead of the display of the thumbnail packet D7 of the pattern C. In the pattern D, the thumbnail packets D1 to D3 near the top, the thumbnail packet D8 displayed, and the thumbnail packets D6, D7, D9, and D10 before and behind the thumbnail packet D8 displayed are stored in the page memory 45. The thumbnail packet D5 is further deleted from the page memory 45 and the thumbnail packet D10 is added anew.

A pattern E indicates a screen on which, moving back from the display of the thumbnail packet D8 of the pattern D, the data of the thumbnail packet D7 is displayed again. In the pattern E, the thumbnail packets D1 to D3 near the top, the thumbnail packet D7 displayed, and the thumbnail packets D5, D6, D8, and D9 before and behind the packet D7 are stored in the page memory 45. In this case, the deleted thumbnail packet D5 is read into the page memory 45 again and the thumbnail packet D10 is deleted from the page memory 45 again.

A pattern F indicates a screen on which, further moving back from the display of the thumbnail packet D7 of the pattern E by one packet, the data of the thumbnail packet D6 is displayed again. In the pattern F, the thumbnail packets D1 to D3 near the top, the thumbnail packet D6 displayed, and the thumbnail packets D4, D5, D7, and D8 before and behind the thumbnail packet D6 are stored in the page memory 45. In this case, the deleted thumbnail packet D4 is read into the page memory 45 again and the thumbnail packet D9 is deleted from the page memory 45 again.

In this way, a thumbnail packet stored in the page memory 45 changes at any time according to the switching of a thumbnail group displayed on the control panel 50.

In this way, data of any one of the thumbnail packets stored in the page memory 45 is displayed on the control panel 50. However, since speed of readout from the page memory 45 is high, display speed does not fall.

Even when an additional thumbnail packet is read from the HDD 47 as in the patterns C and D, since thumbnail packets before and behind a thumbnail packet displayed are always present in the page memory 45, display speed is high. Even when the user operates (touches) the arrow icons 61 and 62 to forward thumbnail display, since additional reading is completed while the user checks thumbnail images displayed, the user does not feel a delay in display.

When an identical document file displayed last time is selected again or when a document file just scanned by the scanner unit 2 is selected, since the thumbnail packets D1 to D3 near the top are present in the page memory 45, display of a top screen right after the selection is quickly performed.

When a document is scanned by the scanner unit 2, the thumbnail packets D1, D2, and D3 to D8 at the top of the scanned document are held in the page memory 45 until another document is scanned or another document file is selected. Thus, when a document file just scanned by the scanner unit 2 is selected, the thumbnail packets D1 to D8 are not read again from the HDD 47 and display of top screen thumbnails is quickly performed.

Since a fixed amount of thumbnail data necessary for display processing is secured in the page memory 45 in this way, it is unnecessary to secure thumbnail data of all selected document files in the page memory 45. Therefore, since an unnecessary storage area does not have to be secured in the page memory 45, it is possible to improve efficiency of use of the page memory 45.

In the example in FIGS. 9A and 9B, the three thumbnail packets D1 to D3 at the top are stored in the page memory 45. However, the number of packets can be arbitrarily set. Similarly, two thumbnail packets before and behind a thumbnail packet selected to be displayed are stored in the page memory 45. The number of packets can also be arbitrarily set.

As it is seen from the above explanation, the page-memory control unit 44 constitutes a first control unit that writes thumbnail data in page units created by the thumbnail-image creating unit 42 in the page memory 45, converts the thumbnail data into thumbnail packets in a unit of thumbnail data of plural pages and reads out the thumbnail packets, and stores the thumbnail packets in the HDD 47.

The page-memory control unit 44 also constitutes a second control unit that reads out the thumbnail packets stored in the HDD 47 and stores the thumbnail packets in the page memory 45, selects data of an arbitrary thumbnail packet stored in the page memory 45 in response to user operation, and displays the thumbnail image 61 in a unit of plural pages on the display unit of the control panel 50.

As described above, according to the embodiment of the present invention, compared with the case in which thumbnail data is read out by a unit of one page and displayed on the control panel as in the past, it is possible to quickly perform a display change because thumbnail data for plural pages are read out and displayed on the control panel. It is also possible to effectively use the page memory.

The present invention is not limited to the above explanation and various modifications of the present invention are possible without departing from the scope of claims. For example, the number of thumbnail images that can be displayed on the control panel at a time is not limited to eight. When a size of a document scanned by the scanner unit 2 changes to A4 or A3, it is possible to display thumbnail images of an equivalent size by changing a compression ratio (a thinning-out ratio) of thumbnail images.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
a scanner unit that scans an image of a document;
a control panel that has a display unit that is capable of simultaneously displaying plural thumbnail images;
an image compressing unit that compresses image data of the document scanned by the scanner unit and creates thumbnail data in page units;
a first control unit that writes the thumbnail data in page units in a page memory, converts the thumbnail data into thumbnail packets in a unit of thumbnail data of plural pages and reads out the thumbnail packets, and stores the thumbnail packets in a data storage medium; and
a second control unit that reads out the thumbnail packets stored in the data storage medium and stores the thumbnail packets in the page memory, selects data of an arbitrary thumbnail packet stored in the page memory in response to user operation, and displays a thumbnail image in a unit of plural pages on the display unit of the control panel.

2. An image forming apparatus according to claim 1, wherein the first control unit two-dimensionally writes the thumbnail data of the plural pages in plural adjacent storage areas of the page memory, respectively, and two-dimensionally scans all the plural storage areas and reads out the thumbnail data for the plural pages as a unit from the page memory, and stores the thumbnail data in the data storage medium as thumbnail packets.

3. An image forming apparatus according to claim 1, wherein, when n (n is plural) thumbnail images can be simultaneously displayed on the display unit of the control panel, the thumbnail packet is formed with thumbnail data for m pages (m≦n) as a unit.

4. An image forming apparatus according to claim 1, wherein the second control unit reads out the thumbnail packets stored in the data storage medium by a quantity set in advance at a time and stores the thumbnail packets in the page memory, outputs data of an arbitrary thumbnail packet to the control panel in response to selection operation by a user, and displays a thumbnail image in a unit of plural pages on the display unit.

5. An image forming apparatus according to claim 4, wherein the second control unit stores at least thumbnail packets including thumbnail data of a top page of the document and the selected thumbnail packet, and thumbnail packets located before and behind the selected thumbnail packet in the page memory.

6. An image forming apparatus according to claim 4, wherein
the page memory is capable of holding plural thumbnail packets, and
the second control unit stores thumbnail packets including thumbnail data of a top page of the document, the selected thumbnail packet, and thumbnail packets located before and behind the selected thumbnail packet in the page memory such that a total number of the thumbnail packets is equal to or smaller than the number of thumbnail packets that can be stored in the page memory.

7. An image forming apparatus comprising:
a scanner unit that scans an image of a document;
a control panel that includes a display unit and an operation unit and is capable of simultaneously displaying thumbnail images for plural pages of the document on the display unit;
a transfer control unit that compresses image data of the document scanned by the scanner unit and outputs transfer data including compressed image data and thumbnail data in page units;
a page memory that has a predetermined storage capacity;
a data storage medium that is capable of storing data of plural document files;
a first control unit that writes the transfer data outputted from the transfer control unit in the page memory, reads out compressed image data in page units from the page memory, reads out thumbnail packets in a unit of thumbnail data of plural pages from the page memory, and stores the compressed image data and the thumbnail packets in the data storage medium;
a second control unit that reads out the thumbnail packets stored in the data storage medium, stores a predetermined quantity of thumbnail packets in the page memory, selects data of an arbitrary thumbnail packet in response to operation by a user and outputs the data to the control panel, and displays thumbnail images in a unit of plural pages on the display unit; and
a printer unit that processes the compressed image data stored in the data storage medium and performs print processing.

8. An image forming apparatus according to claim 7, wherein, in writing the transfer data from the transfer control unit in the page memory, the first control unit writes the compressed image data and the thumbnail data in separate storage areas, respectively.

9. An image forming apparatus according to claim 7, wherein the data storage medium stores, in document file units, the compressed image data and the thumbnail packets read out from the page memory under the control by the first control unit.

10. An image forming apparatus according to claim 7, wherein the second control unit stores at least thumbnail packets including thumbnail data of a top page of the document, the thumbnail packet selected by the user, and thumbnail packets located before and behind the selected thumbnail packet in the page memory and displays the data of the thumbnail packet selected by the user on the display unit.

11. An image forming apparatus according to claim 10, wherein
the page memory is capable of storing plural thumbnail packets, and
the second control unit stores thumbnail packets including thumbnail data of a top page of the document, the selected thumbnail packet, and thumbnail packets located before and behind the selected thumbnail packet in the page memory such that a total number of the thumbnail packets is equal to or smaller than the number of thumbnail packets that can be stored in the page memory.

12. An image forming apparatus according to claim 7, wherein
the control panel is capable of selecting an arbitrary thumbnail image from thumbnail images for plural pages displayed on the display unit, and
the printer unit subjects image data of the document corresponding to the selected thumbnail image to print processing.

13. An image forming apparatus according to claim 12, wherein the control panel overlaps a frame image for distinguishing the selected thumbnail image on the selected thumbnail image, when an arbitrary thumbnail image displayed on the display unit is selected.

14. An image forming method for an image forming apparatus including a control panel that includes a display unit that is capable of simultaneously displaying plural thumbnail images, the image forming method comprising:
scanning an image of a document with a scanner unit;
compressing image data of the document scanned by the scanner unit and creating thumbnail data in page units;
writing the thumbnail data in page units in a page memory and converting the thumbnail data into thumbnail packets in a unit of thumbnail data of plural pages and reading out the thumbnail packets;
storing the thumbnail packets read out from the page memory in a data storage medium;
reading out the thumbnail packets stored in the data storage medium and storing the thumbnail packets in the page memory;
selecting data of an arbitrary thumbnail packet stored in the page memory in response to user operation; and
displaying thumbnail images in a unit of plural pages on the display unit of the control panel.

15. An image forming method according to claim 14, wherein
in the writing of the thumbnail data in the page memory, thumbnail data for plural pages are two-dimensionally written in adjacent plural storage areas of the page memory, respectively, and
in the readout of the thumbnail data from the page memory, all the plural storage areas are two-dimensionally scanned to read out the thumbnail data for plural pages from the page memory as a unit.

16. An image forming method according to claim 14, wherein
the display unit of the control panel is capable of simultaneously displaying n (n is plural) thumbnail images,
the thumbnail packet is formed with thumbnail data for m pages (m≦n) pages as a unit,
the thumbnail packets stored in the data storage medium are read out by a quantity set in advance at a time and stored in the page memory,
data of an arbitrary thumbnail packet is selected from the stored thumbnail packets in response to operation by the user and outputted to the control panel, and
thumbnail images in a unit of plural pages are displayed on the display unit.

17. An image forming apparatus according to claim 14, wherein, when the thumbnail packets stored in the data storage medium are read out and stored in the page memory, at least thumbnail packets including thumbnail data of a top page of the document, the selected thumbnail packet, and thumbnail packets located before and behind the selected thumbnail packet are stored in the page memory.

18. An image forming method according to claim 17, wherein
the number of thumbnail packets stored in the page memory is always fixed,
readout of a thumbnail packet from the data storage medium and deletion of a thumbnail packet from the page memory are controlled according to the selection of the thumbnail packet such that a predetermined number of thumbnail packets are stored in series before and behind the selected thumbnail packet, respectively.

19. An image forming method according to claim 14, wherein, when selection of the thumbnail packets is instructed immediately after start of scanning of the document, data of the thumbnail packets created from the image data of the document, which is scanned by the scanner unit, and stored in the page memory is read out and the thumbnail images are displayed on the control panel.

20. An image forming method according to claim 19, wherein the thumbnail packets stored in the page memory are stored until a next document is selected from the data storage medium or a document is read by the scanner unit anew.
